(19) United States
(12) Patent Application Publication
(10) Pub. No.: US 2026/0307379 A1
(43) Pub. Date: Oct. 8, 2026

(54) POLYMER SAFETY GLAZING FOR VEHICLES

(71) Applicant: RO Technologies, LLC, Las Vegas, NV (US)

(72) Inventors: Stephen S. Wilson, Las Vegas, NV (US); Bart E. Wilson, Las Vegas, NV (US)

(21) Appl. No.: 19/714,084

(22) Filed: Jun. 19, 2026

Related U.S. Application Data
(63) Continuation of application No. 18/829,894, filed on Sep. 10, 2024.
Application No. 18/829,894 is a continuation of application No. 18/182,274, filed on Mar. 10, 2023, now Pat. No. 12,109,788.
Application No. 18/182,274 is a continuation of application No. 17/664,018, filed on May 18, 2022, now Pat. No. 11,833,790.
Application No. 17/664,018 is a continuation of application No. 16/819,526, filed on Mar. 16, 2020, now Pat. No. 11,364,715.
(60) Provisional application No. 62/850,966, filed on May 21, 2019.

(51) Int. Cl. B32B 27/36; B32B 7/06; B32B 7/12

(52) U.S. Cl. CPC B32B 27/365; B32B 7/06; B32B 7/12; B32B 27/36; B32B 2255/10; B32B 2255/26; B32B 2307/536; B32B 2307/71; B32B 2605/006

(57) ABSTRACT

A laminate includes a polycarbonate substrate and an ultraviolet hard coat film disposed on the polycarbonate substrate. The ultraviolet hard coat film may include a polyethylene terephthalate (PET) layer, an adhesive interposed between the PET layer and the polycarbonate substrate, and an exterior hard coat disposed on the PET layer opposite the polycarbonate substrate. The exterior hard coat may include UV stabilizers. The laminate may include additional ultraviolet hard coat films stacked on the ultraviolet hard coat film. The laminate may be thermoformed into the shape of a curved vehicle windshield.

### CROSS-REFERENCE TO RELATED APPLICATIONS

This application is a continuation of U.S. application Ser. No. 18/182,274, filed Mar. 10, 2023, which is a continuation of U.S. application Ser. No. 17/664,018, filed May 18, 2022, now U.S. Pat. No. 11,833,790, issued Dec. 5, 2023, which is a continuation of U.S. application Ser. No. 16/819,526, filed Mar. 16, 2020, now U.S. Pat. No. 11,364,715, issued Jun. 21, 2022, which relates to and claims the benefit of U.S. Provisional Application No. 62/850,966, filed May 21, 2019, and entitled “POLYMER SAFETY GLAZING FOR VEHICLES,” the entire contents of which are expressly incorporated herein by reference.

### STATEMENT RE: FEDERALLY SPONSORED RESEARCH/DEVELOPMENT

Not Applicable

### BACKGROUND

### 1. Technical Field

The present disclosure relates generally to safety glazing and, more particularly, to polymer safety glazing for vehicle windows including windshields.

### 2. Related Art

Safety glazing has historically been made of glass. Glass has a hardness that can withstand scratching from windshield wipers and some amount of abrasive debris. It is also very economical and lends itself to mass production techniques. However, glass breaks easily and can present dangerous sharp pieces that can lacerate passengers, causing personal injuries. This problem has been mitigated to a point by tempering, causing the glass to break into small pieces (½″), and by laminating two glass pieces together with a flexible polymer polyvinylbutyral (PVB) core between them in an attempt to hold the small fragments together.

Unfortunately, glass safety glazing is susceptible to pitting by small aggregates and dust in the air, causing obscured vision while traveling toward the sun. Over 15 million glass windshields are replaced each year for pitting and breaking in the USA alone. Moreover, laminated glass-PVB-glass windshields cannot be recycled because the PVB core contaminates the glass.

Considering the drawbacks of glass safety glazing, laceration of passengers remains a longstanding problem with no ideal solution. For example, 30 years of research has attempted to place a polymer coating or layer on the interior of a glass windshield without any commercial success.

Polycarbonate exhibits superior impact resistance and is used for vehicle glazing in auto racing and off-road vehicles. However, polycarbonate is so soft a material that it scratches and pits too easily for use in commercial or public vehicles. To date, there is no available direct hard coating to overcome these durability issues. Therefore, polycarbonate windshields are currently restricted to motorcycles on public roads. For example, Saudi Basic Industries Corporation (SABIC) is the producer of LEXAN branded polycarbonate. In their 2016 Department of Transportation (DOT) Guidebook regarding LEXAN sheet products, they state, “Except for motorcycle windshields, SABIC's thermoplastics materials generally cannot be used for forward facing exterior glazing . . . ”

### BRIEF SUMMARY

The present disclosure contemplates various systems and methods for overcoming the above drawbacks accompanying the related art. One aspect of the embodiments of the present disclosure is a laminate including a polycarbonate substrate and an ultraviolet hard coat film disposed on the polycarbonate substrate. The ultraviolet hard coat film may include a polyethylene terephthalate (PET) layer, an adhesive interposed between the PET layer and the polycarbonate substrate, and an exterior hard coat disposed on the PET layer opposite the polycarbonate substrate. The exterior hard coat, the PET layer, and/or the adhesive may include UV stabilizers.

The polycarbonate substrate may be 3-8 mm thick. The PET layer may be 2-6 mil thick. The exterior hard coat may be 2-10 microns thick. The exterior hard coat may have a gouge pencil hardness of greater than 8 H. The adhesive may be a pressure sensitive adhesive.

The laminate may include an interior hard coat disposed on the polycarbonate substrate opposite the PET layer. The interior hard coat may have a gouge pencil hardness of 6 H to 8 H.

The ultraviolet hard coat film may be a first of a plurality of ultraviolet hard coat films stacked on the polycarbonate substrate. The plurality of ultraviolet hard coat films may include a second ultraviolet hard coat film disposed on the first ultraviolet hard coat film, the second ultraviolet hard coat film including a second PET layer, a second adhesive interposed between the second PET layer and the first ultraviolet hard coat film, and a second exterior hard coat disposed on the second PET layer opposite the first ultraviolet hard coat film. The second exterior hard coat, the second PET layer, and/or the second adhesive may include UV stabilizers. The adhesive of the first ultraviolet hard coat film may be stronger than the second adhesive.

The laminate may be thermoformed into the shape of a curved vehicle windshield.

Another aspect of the embodiments of the present disclosure is a method. The method may include depositing a UV stabilized hard coat on a first side of a polyethylene terephthalate (PET) carrier, coating a second side of the PET carrier, opposite the first side, with an adhesive, and adhering the second side of the PET carrier to a polycarbonate substrate using the adhesive.

The PET carrier, the UV stabilized hard coat, and the adhesive may define an ultraviolet hard coat film. The method may include winding the ultraviolet hard coat film on a roll prior to adhering the second side of the PET carrier to the polycarbonate substrate. The method may include applying a removable liner to the second side of the PET carrier after the coating. The method may include removing the removable liner from the second side of the PET carrier prior to adhering the second side of the PET carrier to the polycarbonate substrate. The method may include thermoforming the polycarbonate substrate with the adhered ultraviolet hard coat film to the shape of a curved vehicle windshield.

The PET carrier, the UV stabilized hard coat, and the adhesive may define a first ultraviolet hard coat film. The method may include depositing a second UV stabilized hard coat on a first side of a second PET carrier, coating a second side of the second PET carrier, opposite the first side, with a second adhesive, and adhering the second side of the second PET carrier to the first ultraviolet hard coat film using the second adhesive. The adhesive of the first ultraviolet hard coat film may be stronger than the second adhesive. The second PET carrier, the second UV stabilized hard coat, and the second adhesive may define a second ultraviolet hard coat film.

The method may include thermoforming the polycarbonate substrate with adhered first and second ultraviolet hard coat films to the shape of a vehicle windshield. The method may include peeling off the second ultraviolet hard coat film to reveal the first ultraviolet hard coat film. The method may include depositing a new second UV stabilized hard coat on a first side of a new second PET carrier, coating a second side of the new second PET carrier, opposite the first side, with a new second adhesive, and adhering the second side of the new second PET carrier to the first ultraviolet hard coat film using the new second adhesive.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 shows a laminate that is thermoformed into the shape of a vehicle windshield and installed in a vehicle according to an embodiment of the present disclosure;

FIG. 2 is a cross-sectional view of the laminate taken along the line 2-2 in FIG. 1; and

FIG. 3 shows an example operational flow according to an embodiment of the present disclosure.

### DETAILED DESCRIPTION

The present disclosure encompasses various embodiments of a laminate for use as a vehicle windshield and a manufacturing method thereof. The detailed description set forth below in connection with the appended drawings is intended as a description of several currently contemplated embodiments and is not intended to represent the only form in which the disclosed invention may be developed or utilized. The description sets forth the functions and features in connection with the illustrated embodiments. It is to be understood, however, that the same or equivalent functions may be accomplished by different embodiments that are also intended to be encompassed within the scope of the present disclosure. It is further understood that relational terms such as first and second and the like are used solely to distinguish one from another entity without necessarily requiring or implying any actual such relationship in order between such entities.

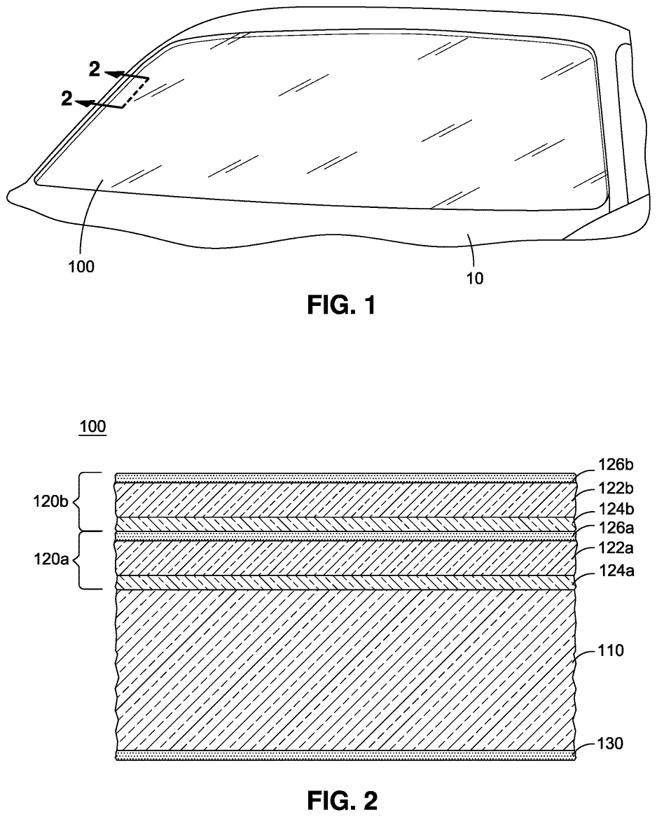

FIG. 1 shows a laminate 100 that is thermoformed into the shape of a vehicle windshield and installed in a vehicle 10 according to an embodiment of the present disclosure. FIG. 2 is a cross-sectional view of the laminate 100 taken along the line 2-2 in FIG. 1. As shown in FIG. 2, the laminate 100 may including a polycarbonate substrate 110 and one or more ultraviolet hard coat films 120 (120a, 120b, etc.) disposed on the polycarbonate substrate 110. By disposing the one or more ultraviolet hard coat films 120 on the polycarbonate substrate 110, the polycarbonate substrate 110 can be protected from scratching and pitting by windshield wipers and debris during use. In this way, the laminate 100 may combine the impact resistance of polycarbonate with the durability needed for widespread vehicle use, all while avoiding the safety hazards associated with glass windshields.

Unlike prior attempts to apply hard coating to polycarbonate, the ultraviolet hard coat film 120a includes a polyethylene terephthalate (PET) layer 122a serving as a carrier, which may be adhered to the polycarbonate substrate 110 by an adhesive 124a interposed therebetween. A UV stabilized exterior hard coat 126a may be disposed on the PET layer 122a opposite the polycarbonate substrate 110, with the PET layer 122a, adhesive 124a, and exterior hard coat 126a defining the ultraviolet hard coat film 120a. The exterior hard coat 126 a may have a gouge pencil hardness of greater than 8 H, making the laminate 100 far more durable than the polycarbonate substrate 110 would be alone. By using the PET layer 122a as a carrier, the exterior hard coat 126a can be applied without the difficulties that would arise if one were to attempt to apply the exterior hard coat 126a to the polycarbonate substrate 110 directly. For example, the polycarbonate substrate 110 may be too soft to support the hard coat 126a, the difference in thermal expansion coefficient between the polycarbonate substrate 110 and the hard coat 126a may cause the hard coat 126a to fracture over time, and/or the hydrophilic quality of the polycarbonate substrate 110 may cause absorbed water to lift the hard coat 126a. These concerns may be avoided by applying the hard coat 126a to the PET layer 122a and allowing the PET layer 122a to “float” on the polycarbonate substrate 110 with the adhesive 124a interposed therebetween.

As shown in the example of FIG. 2, the ultraviolet hard coat film 120a may be a first of a plurality of ultraviolet hard coat films 120 (120a, 120b, etc.) stacked on the polycarbonate substrate 110. By way of example, a second ultraviolet hard coat film 120b may include and be defined by a PET layer 122b, an adhesive 124b, and an exterior hard coat 126b, which may be the same as the PET layer 122a, adhesive 124a, and exterior hard coat 126a, respectively, except that the adhesive 124b may be interposed between the PET layer 122b and the first ultraviolet hard coat film 120 (e.g. the exterior hard coat 126a thereof). Additional (e.g. third, fourth, etc.) ultraviolet hard coat films 120 may be applied in the same way. When a laminate 100 having more than one ultraviolet hard coat film 120 becomes unacceptably degraded over time during the life of the vehicle windshield or other window (e.g. due to chips, oxidation, etc.), the outermost ultraviolet hard coat film 120 may simply be peeled off and removed, revealing the fresh ultraviolet hard coat film 120 beneath. To this end, the adhesive 124a of the first ultraviolet hard coat film 120a may be stronger than the adhesive 124b etc. used for additional ultraviolet hard coat films 120 (and in some cases the adhesives 124b etc. may have further decreasing strength with each additional ultraviolet hard coat film 120). In this way, the first ultraviolet hard coat film 120a may remain adhered to the polycarbonate substrate 110 while another ultraviolet hard coat film 120 is peeled off. It is contemplated, for example, that the first ultraviolet hard coat film 120a may be intended to remain on the polycarbonate substrate 110 for the life of the laminate 100, with additional hard coat films 120 being removable (and possibly replenishable as described below) as needed. Along the same lines, each such additional ultraviolet hard coat film 120 beyond the first 120a may be provided with a tab or other means for easy peel-away during the life of the laminate 100.

The PET layer 122a of the ultraviolet hard coat film 120a may be 2-6 mil thick (1 mil=1 thousandth of an inch) and may be, for example, a biaxially-oriented polyethylene terephthalate (BoPET) sold under the registered trademark Mylar owned by the DuPont Company. The exterior hard coat 126a may be 2-10 microns (e.g. 5 microns) thick and may be, for example, a UV-curable polysiloxane-acrylic hybrid resin, such as a UV-curable resin marketed by DIC Corporation. In addition to having a gouge pencil hardness of greater than 8 H, the exterior hard coat 126a may pass the abrasion test #18 specified in the American National Standards Institute (ANSI) Z26.1-1996 standard and the one-year weather test #16 specified in the ANSI Z26.1-1996 standard. As noted above, the exterior hard coat 126a may be UV-stabilized, for example, by the inclusion of UV stabilizers such as hydroxyphenyl-benzotriazole or hydroxyphenyl-triazine UV absorbers. By including UV stabilizers in the exterior hard coat 126a, degradation of the PET carrier 122a and adhesive 124a caused by ultraviolet radiation in sunlight (e.g. yellowing or becoming brittle) can be prevented or slowed during the life of the ultraviolet hard coat film 120a. It is contemplated that UV stabilizers may be additionally or alternatively included in the PET carrier 122a and/or the adhesive 124a. The adhesive 124a may be 10-25 microns (e.g. 25 microns) thick and may be, for example, a pressure sensitive adhesive (PSA) such as a low tack PSA having a peel strength determined as a constant load per unit width needed for peeling of about 30 grams per inch. The components of any additional ultraviolet hard films 120 beyond the first ultraviolet hard coat film 120a may have the same or similar specifications. The underlying polycarbonate substrate 110 may be 3-8 mm (e.g. 4 mm) thick.

As shown in FIG. 2, the laminate 100 may further include an interior hard coat 130 disposed on the polycarbonate substrate 110 opposite the PET layer 122a. Because the interior hard coat 130 will be the inward-facing surface of the windshield, it will not be subject to the same abrasions and impacts as the exterior hard coat 126a and need not be held to the same standards. As such, the interior hard coat 130 may be softer than the exterior hard coat 126a, thus mitigating the difficulties discussed above with respect to directly applying the exterior hard coat 126a to the polycarbonate substrate 110. The interior hard coat 130 may have a gouge pencil hardness of only 6 H to 8 H, for example. The interior hard coat 130 need not necessarily pass the abrasion test 190 13 specified in the ANSI Z26.1-1996 standard or the one-year weather test #16 specified in the ANSI Z26.1-1996 standard. Like the exterior hard coat 126a, the interior hard coat 130 may be 2-10 microns (e.g. 5 microns) thick and may be, for example, a UV-curable polysiloxane-acrylic hybrid resin, such as a UV-curable resin marketed by DIC Corporation. Because it will not be exposed directly to sunlight, the interior hard coat 130 may or may not have UV stabilizers.

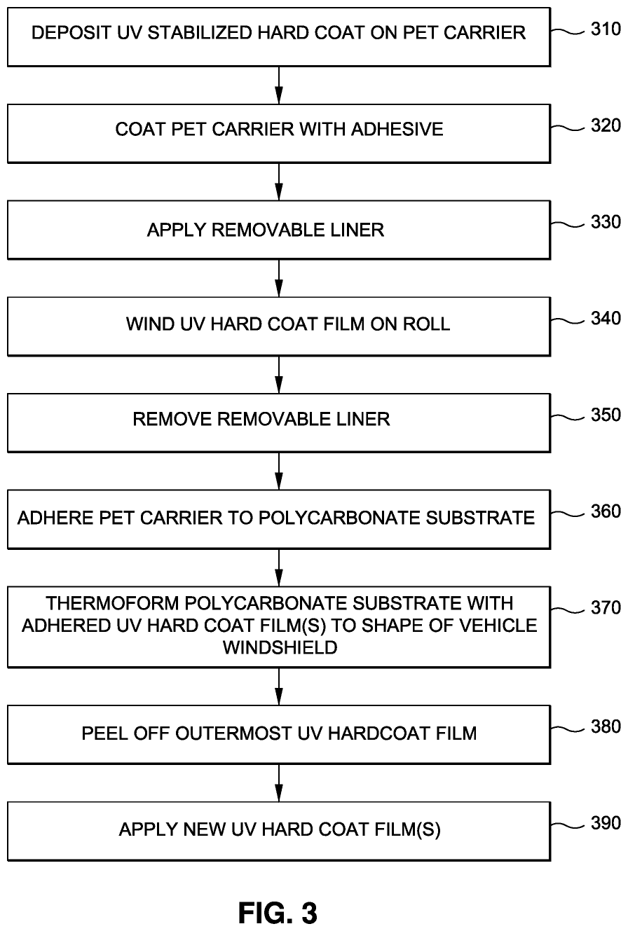

FIG. 3 shows an example operational flow according to an embodiment of the present disclosure. The operational flow may begin with depositing a UV stabilized hard coat that will serve as an exterior hard coat 126a on a first side of a PET carrier 122a (step 310). The exterior hard coat 126a is preferably wet deposited onto the PET carrier 122a but may be applied according to any appropriate methods including spin coating, dip coating, or vacuum deposition. Before or after the exterior hard coat 126a is applied, the PET carrier 122a may be coated on the opposite side with the adhesive 124a (step 320). These three elements, the PET carrier 122a, adhesive 124a, and exterior hard coat 126a, may be permanently bonded to each other and can be collectively regarded as the ultraviolet hard coat film 120a. Once the adhesive 124a is coated on the PET carrier 122a, a removable liner may be applied to the same side of the PET carrier 122a to protect the adhesive 124a (step 330). The ultraviolet hard coat film 120a may then be wound on a roll to form a roll-to-roll processing web that may be about 2 meters wide (step 340). The operational flow of steps 310-340 may produce a roll of the ultraviolet hard coat film 120a at a rate of about 30 meters per minute.

As the ultraviolet hard coat film 120a is unwound from the roll, the removable liner may be removed to expose the adhesive 124a (step 350), and the PET carrier 122a may be adhered to the polycarbonate substrate 110 by the exposed adhesive 124a (step 360). For example, the ultraviolet hard coat film 120a may be dry nipped to the flat polycarbonate substrate 110 by rollers. With the ultraviolet hard coat film 120a having been adhered to the polycarbonate substrate 110, the laminate 100 may be ready for thermoforming to the desired final shape of the windshield or other window. However, as described above and shown in FIG. 2, the laminate 100 may include additional ultraviolet hard coat films 120b, etc., which may later be peeled off one at a time as they degrade with use. In this case, steps 310-360 may be repeated for each additional ultraviolet hard coat film 120, except that each subsequent ultraviolet hard coat film 120 is adhered to the preceding ultraviolet hard coat film 120 of the stack rather than to the polycarbonate substrate 110 in step 360. Once the desired number of ultraviolet hard coat films 120 is stacked on the polycarbonate substrate 110, the entire laminate 110 including the polycarbonate substrate 110 and one or more adhered ultraviolet hard coat films 120 may be 2D or 3D thermoformed to create the windshield or other window (step 370). The thermoforming temperature may be typically about 180 degrees Celsius and may utilize a windshield-shaped pattern or mold surface to form a properly sized 2D or 3D shaped vehicle windshield for installation in a vehicle 10 (see FIG. 1).

As explained above, it is contemplated that a laminate 100 having more than one ultraviolet hard coat film 120 may allow for the outermost ultraviolet hard coat film 120 to be peeled off and removed to reveal a fresh ultraviolet hard coat film 120 beneath. In this respect, the operational flow of FIG. 3 may continue during the life of the laminate 100 that has been installed in a vehicle 10. When the outermost ultraviolet hard coat film 120 becomes unacceptably degraded over time, it may be peeled off to reveal the next ultraviolet hard coat film 120 underneath (step 380).

Following removal of one or more ultraviolet hard coat films 120 in step 380, it is further contemplated that the set of ultraviolet hard coat films 120 may in some cases be replenished to avoid any degradation to the first, innermost ultraviolet hard coat film 120a and prolong the life of the laminate 100. It is envisioned that this first ultraviolet hard coat film 120a would generally not be removed, as doing so would expose the softer polycarbonate substrate 110 which may not conform to the same standards for use in the vehicle 10. As such, the operational flow of FIG. 3 may include a step of applying one or more new ultraviolet hard coat films 120 to the first ultraviolet hard coat film 120a or to the remaining stack of ultraviolet hard coat films 120 (step 390). For example, steps 310-360 may be performed for each additional new ultraviolet hard coat film 120, except that, in step 360, the new ultraviolet hard coat film(s) 120 may be added to the laminate 100 while the laminate 100 is already installed in the vehicle 10 and thus after it has been thermoformed. This may be done, for example, by wet laminating the new ultraviolet hard coat film(s) 120 to the stack and shrinking them with a heat gun or blow dryer to conform them to the existing shape of the laminate 100 while applying pressure using a card or squeegee. In some cases, such additional ultraviolet hard coat film(s) may be applied using a sacrificial layer serving as a female mold cavity as described in commonly owned U.S. application Ser. No. 16/778,928, filed Jan. 31, 2020 and entitled “THERMOFORM WINDSHIELD STACK WITH INTEGRATED FORMABLE MOLD,” the entire contents of which is expressly incorporated herein by reference.

At the end of the life of the laminate 100, there is no contamination as in the case of conventional laminated glass-PVB-glass windshields. Thus, the polycarbonate substrate 110 can easily be recycled, resulting in less waste and benefitting the environment.

In the above examples of the laminate 100, it is assumed that at least one ultraviolet hard coat film 120 is adhered to the polycarbonate substrate 110 prior to thermoforming into the desired shape of the windshield or other window. However, the disclosure is not intended to be so limited, and it is contemplated that the one or more ultraviolet hard coat films 120 may be applied after the polycarbonate substrate 110 is already thermoformed. For example, the same techniques described above in relation to replenishing the stack of ultraviolet hard coat films 120 in step 390 may be used to apply the original one or more ultraviolet hard coat films 120.

The above description is given by way of example, and not limitation. Given the above disclosure, one skilled in the art could devise variations that are within the scope and spirit of the invention disclosed herein. Further, the various features of the embodiments disclosed herein can be used alone, or in varying combinations with each other and are not intended to be limited to the specific combination described herein. Thus, the scope of the claims is not to be limited by the illustrated embodiments.

1-20. (canceled)

21. A laminate comprising:
a polycarbonate substrate;
a first polymer carrier disposed on the polycarbonate substrate, the first polymer carrier including an exterior hard coat opposite the polycarbonate substrate; and
an interior hard coat disposed on the polycarbonate substrate opposite the first polymer carrier, the interior hard coat being softer than the exterior hard coat.

22. The laminate of claim 21, wherein the polycarbonate substrate is 3-8 mm thick.

23. The laminate of claim 21, wherein the first polymer carrier is 2-6 mil thick.

24. The laminate of claim 21, wherein the exterior hard coat is 2-10 microns thick.

25. The laminate of claim 21, further comprising a first adhesive between the first polymer carrier and the polycarbonate substrate.

26. The laminate of claim 25, wherein the first adhesive is a pressure sensitive adhesive.

27. The laminate of claim 25, further comprising:
a second polymer carrier disposed on the first polymer carrier; and
a second adhesive between the first and second polymer carriers.

28. The laminate of claim 27, wherein the first adhesive is stronger than the second adhesive.

29. The laminate of claim 21, wherein the laminate is thermoformed into the shape of a curved vehicle windshield.

30. A laminate comprising:
a polycarbonate substrate;
a polymer carrier adhered to the polycarbonate substrate by an adhesive, the polymer carrier including an exterior hard coat opposite the polycarbonate substrate; and
an interior hard coat disposed on the polycarbonate substrate opposite the polymer carrier, the interior hard coat being softer than the exterior hard coat.

31. A method comprising:
disposing a first hard coat on a first polymer carrier;
disposing the first polymer carrier on a first side of a polycarbonate substrate; and
disposing a second hard coat on a second side of the polycarbonate substrate opposite the first side, the second hard coat being softer than the first hard coat.

32. The method of claim 31, further comprising winding a film including the first polymer carrier and the first hard coat on a roll.

33. The method of claim 31, further comprising thermoforming the polycarbonate substrate with the first polymer carrier disposed thereon to the shape of a curved vehicle windshield.

34. The method of claim 31, wherein said disposing the first polymer carrier on the first side of the polycarbonate substrate comprises adhering the first polymer carrier to the first side of the polycarbonate substrate using a first adhesive provided on the first polymer carrier.

35. The method of claim 34, further comprising applying a removable liner to the first adhesive.

36. The method of claim 34, further comprising disposing a second polymer carrier on the first polymer carrier, wherein a second adhesive is provided between the first and second polymer carriers.

37. The method of claim 36, wherein the first adhesive is stronger than the second adhesive.

38. The method of claim 36, further comprising thermoforming the polycarbonate substrate with the first and second polymer carriers to the shape of a vehicle windshield.

39. The method of claim 38, further comprising peeling off the second polymer carrier to reveal the first polymer carrier.

40. The method of claim 39, further comprising adhering a new second polymer carrier to the first polymer carrier using the second adhesive.
